(19) United States
(12) Patent Application Publication
(10) Pub. No.: US 2020/0027008 A1
(43) Pub. Date: Jan. 23, 2020

(54) METHODS, SYSTEMS, ARTICLES OF MANUFACTURE, AND APPARATUS TO CONTROL DATA ACQUISITION SETTINGS IN EDGE-BASED DEPLOYMENTS

(71) Applicant: Intel Corporation, Santa Clara, CA (US)

(72) Inventors: Michael Nolan, Maynooth (IE); David Coates, Leixlip (IE); Marcin Spoczynski, Leixlip (IE); Michael McGrath, Virginia (IE); Dáire Healy, Enfield (IE)

(21) Appl. No.: 16/586,425

(22) Filed: Sep. 27, 2019

(51) Int. Cl. G06N 5/02; G05B 13/04; H04L 29/08; G06F 17/13

(52) U.S. Cl. CPC G06N 5/022; G06F 17/13; H04L 67/12; G05B 13/042

(57) ABSTRACT

Methods, systems, articles of manufacture and apparatus to control data acquisition settings in edge-based deployments are disclosed. An example apparatus includes a model generator to transform sensor data to variance data, and differentiate the variance data to generate variance rate of change data. The example apparatus also includes a model analyzer to determine subsets of the variance rate of change data associated with respective data acquisition settings, determine a count of data points corresponding to the rate of change data, and determine an interval spacing value based on the count of the data points and a number of subsets of the variance rate of change data. The example apparatus also includes a solution identifier to calculate candidate solutions at respective ones of the data points corresponding to the interval spacing value, respective ones of the candidate solutions corresponding to respective data acquisition settings of a data acquisition system, and select one of the candidate solutions satisfying an operational threshold of the data acquisition system.

### FIELD OF THE DISCLOSURE

This disclosure relates generally to data acquisition tuning, and, more particularly, to methods, systems, articles of manufacture, and apparatus to control data acquisition settings in edge-based deployments.

### BACKGROUND

In recent years, the Internet of things (IoT) and cloud-based computing has increased the role of edge devices and created the need for enhanced services and computing power at the network edge. Edge devices, such as data acquisition systems, measure real-world variables for use in operational or decision-making contexts and operate in industrial, cyber-physical systems, IoT systems, and other edge use cases.

### BRIEF DESCRIPTION OF THE DRAWINGS

FIG. 1 illustrates an example edge-based system to control data acquisition settings in edge-based deployments.

FIG. 2 illustrates an example edge-based system to control data acquisition settings in edge-based deployments.

FIG. 3 is a block diagram of an example system tuner of the example edge-based system of FIGS. 1 and/or 2.

FIG. 4A is a diagram of example raw sensor data that includes an overlay of setting configurations, variance data, and a first threshold.

FIG. 4B is a diagram of an example model that describes the variance data and a first threshold.

FIG. 4C. is a diagram of an example model that describes the rate of change of the variance data model of FIG. 4B.

FIGS. 5-10 are flowcharts representative of machine-readable instructions which may be executed to implement the example system tuner of FIGS. 1, 2, and/or 3.

FIG. 11 is a block diagram of an example processing platform structured to execute the instructions of FIGS. 5-10 to implement the example system tuner of FIGS. 1, 2, and/or 3.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

In recent years, Internet of things (IoT) devices and/or edge-based devices, have brought cloud computing capabilities to local devices (e.g. edge computing) in an effort to improve the speed of data transmission and processing. Example edge-based devices include, but are not limited to, controllers, transmitters, valves, actuators, sensors, etc. and enable data to be gathered and processed at the network edge, where the local device and users reside.

These example edge-based devices and/or data acquisition systems typically include multiple settings and are often tuned based on, for instance, data acquisition frequency (e.g., sampling rate). Proper tuning of data acquisition systems ensures high quality data and/or accuracy but can be a time-consuming process. Typically, tuning data acquisition systems requires knowledge of the system settings and configurations, multiple test runs to find an optimal configuration, and are model-driven. In real-world applications, data can be transient and may require any number of different setting configurations to maintain an optimal data acquisition quality. Moreover, such transient behaviors of a control environment may not be known to personnel chartered with the responsibility of designing and/or implementing particular setting configurations when such settings are initially contemplated. As such, subsequent re-configuration efforts are required to correct the settings, thereby resulting in wasted personnel resources and/or inaccurate or erroneous data acquisition.

Data acquisition systems are used in a wide array of applications, each having unique constraints and transient environments that require specific tuning. Example data acquisition system applications include, but are not limited to, electrical monitoring systems (e.g., power stations, laptop/smartphone/tablet/IoT battery powered systems, autonomous vehicle power monitoring, etc.), physics research systems (e.g., The European Organization for Nuclear Research (CERN), National Aeronautics and Space Administration (NASA), experiments measuring real-world particles at a fast and accurate level, etc.), high-tech manufacturing systems (e.g., lithography, plasma cutting, chemical polishing, etc.), autonomous control systems (e.g., drone control, autonomous vehicle control, robotics, etc.), and environmental monitoring systems (e.g., weather monitoring, air quality systems, flood warning systems, etc.). Each of the mentioned applications often have transient environments and need constant data acquisition system tuning to maintain a high level of data acquisition accuracy.

Examples disclosed herein include an example system tuner to optimize an example data acquisition system to ensure the required quality of data satisfies application specific constraints. In some examples, the data acquisition system contains settings to allow the data acquisition system to be modified for better (e.g., more accurate, faster, etc.) data acquisition. In such examples, these settings are configured and sampled in different combinations to determine configuration settings that satisfy one or more application specific constraints in a manner that is not hindered by the discretionary choices of control system personnel and/or transient conditions of the environment.

In some examples, the system tuner is located at the data acquisition system and optimizes the data acquisition system without needing a separate device. In other examples, the system tuner is located in a separate client device (e.g., Internet gateway, laptop, cellular phone, tablet, server, etc.) and optimizes the data acquisition system through a network connection (e.g., Internet, USB, etc.).

In some disclosed examples, the system tuner acquires raw sensor data for each possible setting configuration and generates variance data based on that raw sensor data. Variance data measures how far a set of numbers are spread out from their average value and, when reduced (e.g., minimized), increases the accuracy and/or quality of the data being measured. Generally speaking, a series or subset of data points that exhibit a relatively large amount of variance suggests that a process associated with those data points is transient and/or otherwise not in a steady state. In some circumstances, a relatively large variance suggests a relatively poor configuration of the data acquisition system responsible for obtaining the data (e.g., sensor data points). Variance data is generated from the raw sensor data and stored in a repository (e.g., data storage) as a variance data set. In such examples, the amount of data acquired (e.g., raw sensor data samples) to generate variance data for each configuration is determined (e.g., by the user) before the tuning process is initialized.

In some disclosed examples, the variance data set is modeled and/or otherwise analyzed using different methods to ensure the developed solution behaves in a manner that satisfies performance expectations and/or constraints (e.g., in an optimal manner). For example, the different methods, used for modeling and characterizing the data, reduce (e.g., minimize) temporal constraints and ensure that subsequent variance data remains below an application acceptable threshold once a potential solution has been determined. Continuous tuning of the data acquisition system is accomplished by gathering new raw sensor data to then be re-modeled and re-analyzed and is described in further detail below.

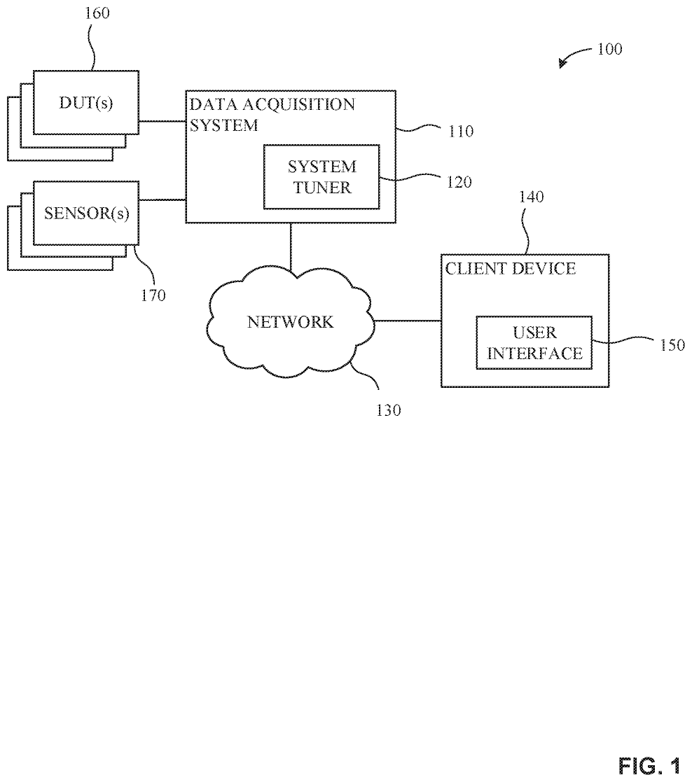

In the illustrated example of FIG. 1, an edge-based deployment environment 100 includes an example data acquisition system 110, an example system tuner 120, an example network 130, an example client device 140, an example user interface 150, an example device under test (DUT) 160, and an example sensor 170. The example data acquisition system includes, but is not limited to a finite state machine (FSM), an analog-to-digital converter (ADC), a digital-to-analog converter (DAC), etc. The example digital acquisition system may include any number and/or type of input/output (I/O), such as logic probes, in-circuit test probes, pulse detectors, etc. Generally speaking, the data acquisition system may operate as an IoT device at a network edge. The example data acquisition system 110 of FIG. 1 may be communicatively connected to any number and/or type of DUT 160. Additionally, the example data acquisition system 110 may utilize one or more sensors 170 to capture/acquire one or more mechanical, electrical, thermal, and/or optical characteristics of the example DUT 160.

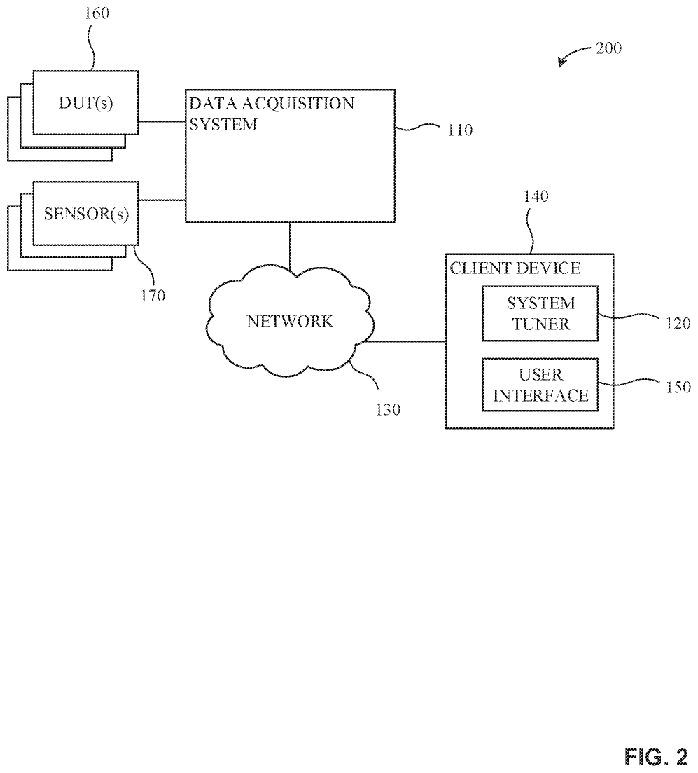

The example client device 140 of FIG. 1 includes, but is not limited to, one or more computing devices communicatively connected to the data acquisition system 110 (e.g., an IoT device). In some examples, the client device 140 invokes the example user interface 150 to retrieve and/or otherwise receive IoT device status information, acquired sensor data and/or enable control system personnel to configure the example IoT device(s) 110. In FIG. 2, the illustrated examples are the same as in FIG. 1 but include a different arrangement of the example system tuner 120.

In the illustrated example of FIGS. 1 and 2, the edge-based deployment environment 100 includes the data acquisition system 110 to acquire data reflecting real-world values. The example data acquisition system 110 receives and/or otherwise retrieves, inputs from one or more sensors 170 and converts those signals into data values that are then transmitted and/or otherwise made available to the example system tuner 120 to be analyzed. As described in further detail below, when the example data acquisition system 110 sends data to the system tuner 120, the system tuner 120 determines an alternate (e.g., improved) setting configuration at which the data acquisition system 110 is to operate, and then manipulates one or more settings of the data acquisition system 110 accordingly. In FIGS. 1 and 2, the example data acquisition system 110 includes and/or is communicatively connected to one or more sensors 170 (e.g. pressure, torque, position, proximity, infrared, photodiode, optic, etc.). Additionally, or alternatively, the data example acquisition system 110 includes any other devices and/or sensors that include settings pertaining to how data is acquired (e.g., a rate of data samples, a sample resolution, a sample dwell deviation, etc.).

In the illustrated example of FIGS. 1 and 2, the system tuner 120 measures and controls setting configurations corresponding to the data acquisition system 110. For example, the system tuner 120 generates and analyzes variance data to determine a particular setting configuration for the data acquisition system 110 that, when changed, causes one or more improvements to the acquired data (e.g., increased data acquisition rate (e.g., to avoid Nyquist errors), increased data resolution, reduced data acquisition rate when real-world transient activity is relatively lower, etc.). In some examples, the system tuner 120 generates and analyzes new variance data on a periodic, aperiodic, scheduled or manual basis to continuously search for data acquisition settings that best fit the current data acquisition environment. In some examples, the system tuner 120 is an application-specific integrated circuit (ASIC), and in some examples the system tuner 120 is a field programmable gate array (FPGA). Alternatively, the system tuner 120 can be software located in the firmware of the data acquisition system 110, in a data acquisition system driver, and/or in an application querying the data from the data acquisition system 110.

In the illustrated example of FIGS. 1 and 2, the edge-based deployment environment 100 includes the network 130 to allow communication between the data acquisition system 110 and the client device 140. In some examples, one or more DUTs 160 and/or one or more sensors 170 are communicatively connected to the data acquisition system 110 via the network 130. The communication provided by the network 130 can be via, for example, the Internet, an Ethernet connection, USB cable, etc.

In the illustrated example of FIGS. 1 and 2, the edge-based deployment environment 100 includes the client device 140 to communicate with the data acquisition system 110. In some examples, the client device 140 receives and/or otherwise retrieves the analyzed data from the system tuner 120 and stores the configuration history and/or data solutions for future reference. In other examples, the client device 140 includes the system tuner 120 as hardware and/or software to optimize the data acquisition system 110. In the illustrated example of FIGS. 1 and 2, the client device 140 is an Intel Sensor Hub (ISH). Alternatively, the client device 140 may be an Internet gateway, a laptop, a cellular phone, a tablet, a server, etc.

In the illustrated example of FIGS. 1 and 2, the edge-based deployment environment 100 includes the user interface 150 to allow one or more users to interact with the edge-based deployment environment 100 of FIGS. 1 and 2. For example, the user interface 150 allows the user to monitor the system tuner 120 and/or the data acquisition system 110. The user interface 150 also allows the user to input desired threshold values, calculation intervals, and/or other calculation parameters. In some examples, the user interface 150 sends visual alerts, audio alerts, and/or a combination thereof, to the user, that are indicative of particular data acquisition system 110 and/or system tuner 120 conditions.

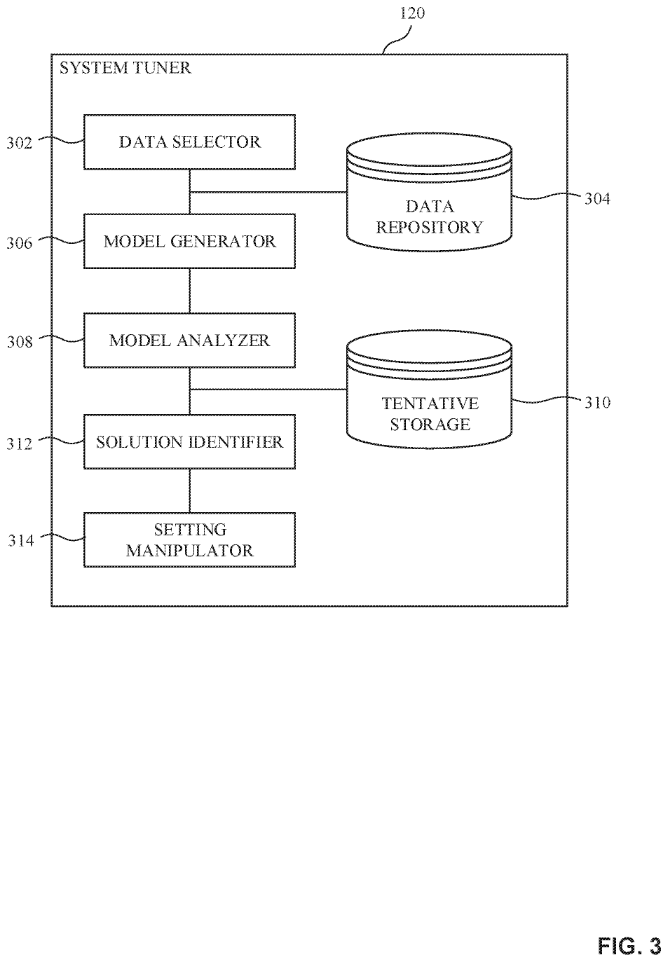

FIG. 3 is a block diagram of the example system tuner 120 of FIGS. 1 and 2. In the illustrated example of FIG. 3, the system tuner 120 includes an example data selector 302, an example data repository 304, an example model generator 306, an example model analyzer 308, an example tentative storage device 310, an example solution identifier 312, and an example setting manipulator 314.

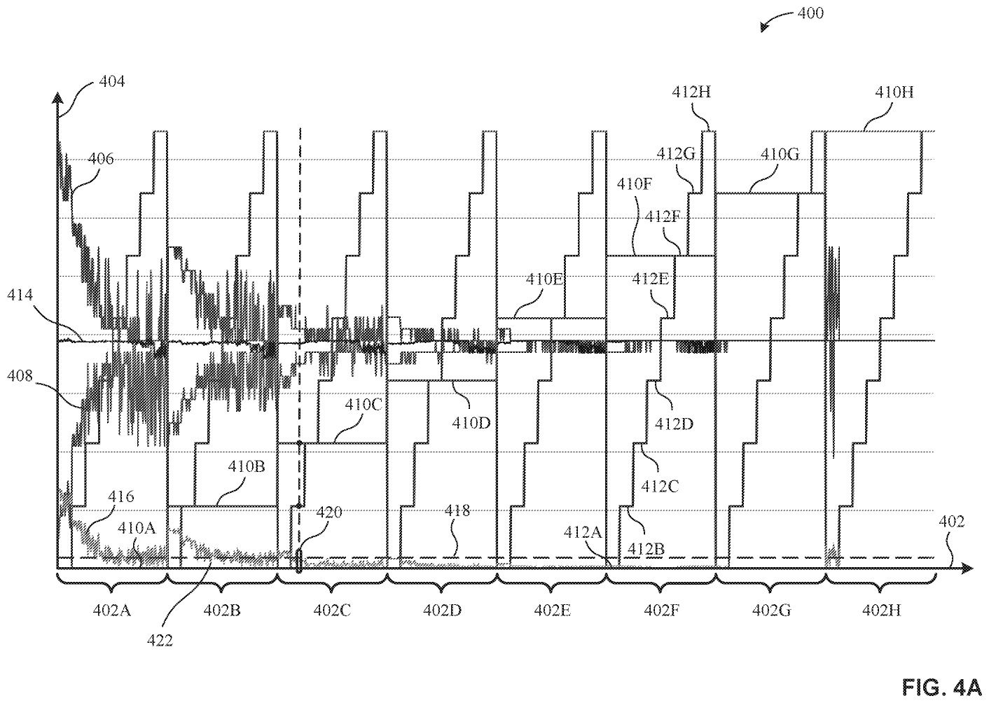

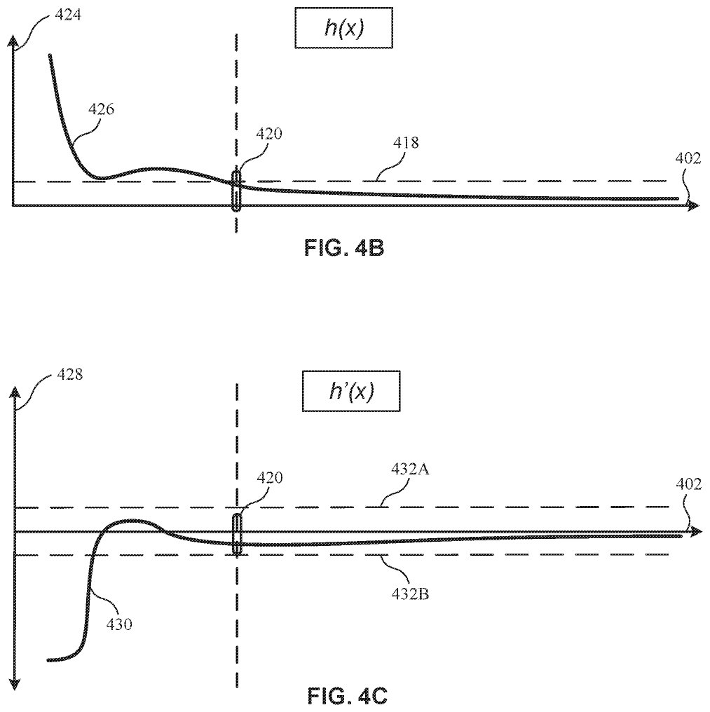

In the illustrated example of FIG. 3, the system tuner 120 includes the data selector 302 to gather raw sensor data and store the data in the data repository 304. In some examples, the raw sensor data is acquired in groups (e.g., configurations). For example, the data selector 302 iteratively acquires a particular number of samples at different configuration settings (sometimes referred to herein as “setting parameters,” “data acquisition settings,” or “sensor configuration settings”) of the example data acquisition system 110 (e.g., different sensor sampling frequencies, different sensor dwell durations, etc.) to be stored in the data repository 304 until a target number of samples have been acquired. An example illustration of how the raw sensor data and the setting configurations correspond is further described in detail with FIG. 4A.

In the illustrated example of FIG. 4A, an X-axis 402 represents each sample gathered by the system tuner 120 and a Y-axis 404 represents the variable being measured by the data acquisition system 110 and/or sensors 170 that is gathered by the system tuner 120. In examples disclosed herein, the Y-axis is measured in milli-amps (mA) to represent an electrical current reading, but such examples are provided for purposes of illustration and not limitation. In other words, the example Y-axis 404 can represent any other variable measured by the sensors 170 and/or the data acquisition system 110. In some examples, raw sensor data shown in FIG. 4A includes maximum sensor data 406, minimum sensor data 408 and average sensor data 414. The average sensor data 414 represents the average values between the maximum sensor data 406 values and the minimum sensor data 408 values and is used to calculate variance data 416. In some examples, the raw sensor data may include one line of data that uses a reference value (e.g., zero, expected value, etc.) to calculate variance data.

In the illustrated example of FIG. 4A, setting parameters are shown as an overlay to the raw sensor data (e.g., maximum sensor data 406, minimum sensor data 408, average sensor data 414) and include a first setting parameter 410 and a second setting parameter 412, where the first setting parameter 412 is also represented as portions of the X-axis and shown as 402A-H. In the illustrated example of FIG. 4A, the setting parameters (the first setting parameter collectively referenced by 410 and the second setting parameter collectively referenced by 412) include eight settings that are represented as step functions 410A-H, 412A-H. While the illustrated example of FIG. 4A includes eight (8) settings, examples disclosed herein are not limited thereto. In some examples, the number of setting parameters are based on the sensors 170 and/or the data acquisition system 110 gathering the raw sensor data. Additionally, and/or alternatively, the example data acquisition system 110 can have any number of different setting parameters that contain any number of different settings. In the illustrated example of FIG. 4A, the second setting parameter 412 shows setting labels 412A-H only in the 402F portion of the X-axis 402, but it should be noted that each portion of the X-axis 402A-H includes the example settings 412A-H.

In the illustrated example of FIG. 4A, the raw sensor data is gathered from left to right and begins at a relatively low configuration (e.g., each setting within the setting parameters are set at their respective lowest values, such as a lowest data capture frequency). For instance, a first setting of the first setting parameter 410A and a first setting of the second setting parameter 412A represent relatively lowest values that are selectable by the example sensors 170 and/or example data acquisition system 110. A particular number of samples of the raw sensor data are gathered by the data selector 302 at an initial configuration and stored in the data repository 304. The second setting parameter 412 then changes to the next incremental setting 412B and the data selector 302 gathers more raw sensor data samples. The iterative process of switching settings continues until raw sensor data has been gathered from each available configuration setting of interest. As illustrated in FIG. 4A, the different configurations are shown from left to right and correspond to the raw sensor data that lies within the setting configuration. In this example, there are 64 possible configurations based on the two example setting parameters 410, 412 each containing eight settings 410A-H, 412A-H (e.g., 8×8 configurations).

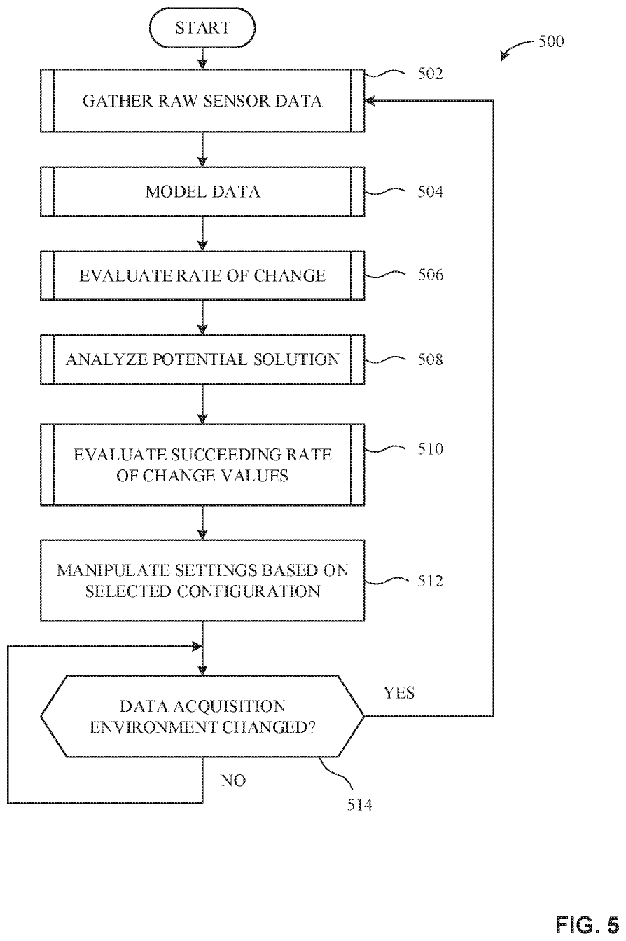

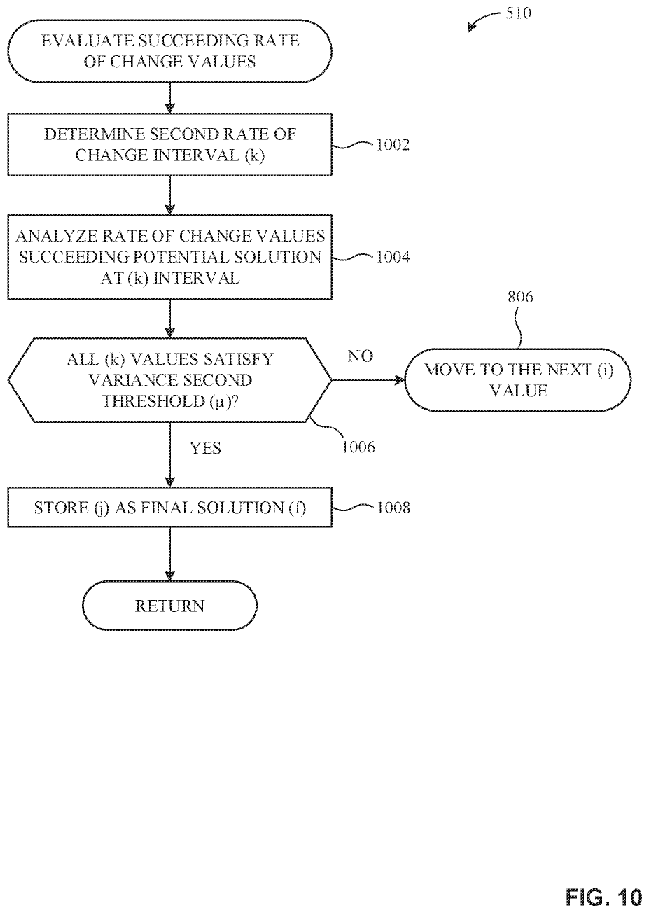

In the illustrated example of FIG. 4A, variance data 416 is calculated by the model generator 306, based on the raw sensor data and shown near the bottom of FIG. 4A as an overlay. For example, the variance data 416 is typically measured as a percentage but may additionally and/or alternatively be measured using the raw sensor data variable (e.g., mA). An example first threshold 418, ε, is shown as a horizontal dashed line and represents an acceptable variance value determined by the user and/or application (e.g., an application that relies upon data acquisition activities of the example data acquisition system 110, such as an industrial control application). For example, variance data 416 satisfies the first threshold 418, E, for any sample that is at or below the first threshold 418, E. More specifically, as shown in FIG. 4A, an example final solution 420 represents the particular sample where every succeeding variance data 416 value, within a second rate of change interval, k, described in further detail in connection with FIGS. 5-10, remains equal to or below the first threshold 418, E. Stated differently, in some examples the variance data 416 satisfies the first threshold 418, ε, during a first instance, but during a subsequent instance the variance data 416 does not satisfy (e.g., exceeds) the first threshold 418. For instance, as shown in FIG. 4A, a local minimum 422 illustrates that although the variance data 416 satisfies the first threshold 418, ε, some subsequent values do not satisfy the first threshold 418, E. Such occurrences are sometimes caused by transient behavior of the application that is being monitored by the example data acquisition system 110. In other words, the monitored environment/application is not at steady state. Additional details regarding the significance of the final solution 420 is described further in reference to FIGS. 5 and 10.

Returning to the illustrated example of FIG. 3, the model generator 306 generates a model for the raw sensor data gathered by the data selector 302. For example, the model generator 306 generates the variance data 416 based on the raw sensor data and generates a model (e.g., variance data model) for that variance data 416. The variance data model is described further in connection with FIG. 4B. To create the model, the variance data 416 is interpolated and modeled, by the example model generator 306, generating the function h(x), where x represents the X-axis 402 samples as shown in FIG. 4A. The example model generator 306 generates the variance data model (h(x)) by, for example, best fitting a polynomial to the variance data 416. In some examples, the model generator 306 generates the variance data model by applying the method of non-linear least squares and implementing floating-point arithmetic. In some examples, a polynomial degree of 16 is used to consider a quantity of nuances of the raw sensor data to be encapsulated. In some examples, the model generator 306 utilizes the fact that the derivative of a function describes the rate of change of that function. As such, the example model generator 306 differentiates the variance data model to generate a rate of change of the variance data (h′(x)). Stated differently, the function h′(x) identifies the rate at which the variance data 416 is changing at any given point within the variance data 416 and is further described in connection with FIG. 4C.

In the illustrated example of FIG. 4B, the X-axis 402 represents each sample gathered by the system tuner 120 and a Y-axis 424 represents a percentage of the variable being measured by the data acquisition system 110 and/or sensors 170. Additionally, and/or alternatively, the Y-axis 424 may represent any other measured variable value. In some examples, the variance data 416 of FIG. 4A, is modeled by the model generator 306, as described above, and is shown as the variance data model 426, h(x), in FIG. 4B. The first threshold 418, ε, from FIG. 4A, is overlaid as a visual reference to indicate the variance data values that satisfy the first threshold 418. The example final solution 420 is also indicated to show that variance values, succeeding the final solution 420, remain below the first threshold 418.

In the illustrated example of FIG. 4C, a Y-axis 428 represents a variance rate (e.g., %/sample, mA/sample, etc.) and includes a positive and negative portion that extend above and below the X-axis 402. In some examples, the variance data model 426, h(x), of FIG. 4B, is differentiated by the model generator 306 to create a variance rate of change model 430, h′(x), as previously described. The example final solution 420 is overlaid to indicate that the variance rate of change value, and succeeding rate of change values, satisfy an example second threshold 432A, 432B (e.g., a variance rate of change threshold window) described below in further detail in connection with the model analyzer 308.

In the illustrated example of FIG. 3, model analyzer 308 analyzes the variance rate of change model 430 and determines a potential solution (e.g., setting configuration) for the current data acquisition system 110. As used herein, a potential solution represents a data sample that satisfies all applied criteria and/or parameters, such as satisfying the first threshold 418, ε, satisfying the second threshold 432A, 432B, p, and/or satisfying one or more application specific parameters. However, because one or more temporally subsequent data samples have not been evaluated, the possibility exists that the potential solution is a local minimum. Examples disclosed herein detect whether such local minimums occur and, if so, continue to evaluate temporally subsequent data samples until another potential solution is identified, in which no further temporally subsequent data samples violate one or more threshold(s).

For example, the model analyzer 308 determines whether a variance data 416 rate of change value satisfies the second threshold 432A, 432B, p, of FIG. 4C, at a particular interval point. In such examples, the second threshold 432A, 432B, p, represents the variance rate of change deemed acceptable by the user and/or application. Stated differently, the second threshold window 432A, 432B represents particular data acquisition system settings that help bring the data acquisition system into a steady state of operation. In the event data points reside beyond the borders of the example threshold window 432A, 432B, then transients may still be occurring. The example model analyzer 308 analyzes the variance rate of change model 430 at a first rate of change interval represented by i. In some examples, the model analyzer 308 determines and/or otherwise generates the first rate of change interval (i) based on a quantity of raw sensor data samples that have been acquired for a particular setting configuration of the example data acquisition system 110. For instance, the variance data 416 of FIG. 4A corresponds to 1280 samples (e.g., variance data points) or 64 possible configurations containing 20 samples each. In this example, the model analyzer 308 sets the first rate of change interval to 1280 samples.

However, and as described above, analyzing all acquired data samples is computationally intensive and time consuming. As such, the example model analyzer 308 determines and/or otherwise generates an interval spacing value q. The interval spacing value, q, is an integer value, defined by the user and/or application, and represents the spacing between each value within the first rate of change interval (i). In some examples, the first rate of change interval is used to reduce the number of variance rate of change values analyzed by skipping variance rate of change values at the specified spacing of the interval spacing value q. For example, if the interval spacing value q is chosen as five, then, the first rate of change interval is as follows: i=[1, 5, 10, 15, . . . , 1275, 1280]. In some examples, the interval spacing value q may be a function that changes the spacing between each value within the first rate of change interval i. In some examples, the interval spacing value is calculated by the example model analyzer 308 based on a ratio of (a) a total number of available/collected data points and (b) a number of subsets of sensor configuration settings that occurred during the collection of those data points.

For example, the model analyzer 308 analyzes the variance rate of change model 430 at values of i (e.g., h′(i)) until one of those values satisfies the second threshold 432A, 432B, μ (e.g., |h′(i)|<μ). The variance rate of change value that satisfies the second threshold 432A, 432B, μ, is stored as the potential solution, represented by j, in the tentative storage device 310. In some examples, the model analyzer 308 keeps track of the first rate of change interval values that have been analyzed to prevent re-analyzing the same values within the interval.

In the illustrated example of FIG. 3, the solution identifier 312 analyzes the potential solution, j. For example, solution identifier 312 analyzes the potential solution by comparing the variance value, at the potential solution j (e.g., h(j)), to the first threshold 418, ε, and other user-defined criteria and/or requirements. In some examples, the first threshold 418, ε, is defined by the user and/or application and is a measure of variance deemed acceptable for the application and/or acquisition environment. In some examples, user-defined criteria and/or additional requirements are analyzed by the solution identifier 312 to determine if the potential solution satisfies the user-defined criteria and/or additional requirements, as well as the first threshold 418, ϵ. In some examples, the user-defined criteria and/or additional requirements are specific to the application and/or are extra features desired by the user.

In some examples, the model analyzer 308 analyzes variance rate of change values that succeed the potential solution j at a second rate of change interval, k, to determine whether the succeeding variance rate of change values are equal to or less than the second threshold 432A, 432B, μ. Stated differently, even if the most recently analyzed data point satisfies one or more thresholds, the example model analyzer 308 selects one or more subsequent data points to verify that the most recently analyzed data point is not a local minimum. While ceasing further data point analysis in response to detecting one data point that satisfies all thresholds of interest will improve computational efficiency by avoiding further calculation of remaining data points that may have been collected, the possibility exists that a subsequent data point violates the thresholds of interest, thereby illustrating a local minimum or false positive. In some examples, the second rate of change interval, k, is the 2^{nd}, 4^{th}, 8^{th}, 16^{th}, . . . , 256^{th} value succeeding the potential solution j. For instance, if the potential solution is at the sample (data) point x=380, then, the second variance rate of change interval is as follows: k=[380, 382, 384, 388, 396, . . . , 652]. In other examples, the second rate of change interval can be a user-defined interval. The purpose of the second rate of change interval is to ensure that all of the variance rate of change data, succeeding the potential solution, satisfies the second threshold 432A, 432B, μ.

The model analyzer 308 analyzes the rate of change values, succeeding (subsequent to) the potential solution j, to determine whether the potential solution j is the final solution 420 represented by f and shown in FIG. 4A. If the model analyzer 308 determines that the potential solution satisfies the second threshold 432A, 432B, μ, for every value in the second rate of change interval k, the model analyzer 308 stores the final solution 420 f, in the tentative storage device 310. In response to determining the final solution, the example solution identifier 312 instructs the model analyzer 308 to stop and/or otherwise cease further data point analysis in an effort to conserve computing resources. In other words, because all further data points are expected to remain within variance rate of change window thresholds, there is no need to analyze those data points (e.g., see the data points to the right of 420 in FIGS. 4B and 4C). However, in the event that a subsequently analyzed data point fails to satisfy one or more thresholds, then the example discards any previously identified potential solution and continues to analyze data points thereafter.

In the illustrated example of FIG. 3, the tentative storage device 310 stores the potential solution(s), the final solution 420, the thresholds (e.g., the first threshold 418, ε, and the second threshold 432A, 432B, μ), and the intervals (e.g., first rate of change interval i, interval spacing value q, second rate of change interval k), along with the current location within the intervals. For example, the tentative storage device 310 keeps track of the interval values that have already been analyzed to prevent backtracking and re-analyzing data points. Furthermore, the data stored in the tentative storage device 310 may be in any data format such as, binary data, comma delimited data, tab, delimited data, structured query language structures, etc.

In the illustrated example of FIG. 3, the setting manipulator 314 adjusts the data acquisition system 110 settings. Example final settings include, but are not limited to, a number of samples to acquire per unit of time (e.g., a sampling frequency), a sensor dwell duration per sample, a sample resolution, an amount of time allowed to acquire samples, etc. For example, setting manipulator 314 uses the final solution 420 f, determined by the model analyzer 308, to manipulate the data acquisition system 110 settings to match the setting configuration that corresponds to the final solution 420 f.

Manipulating the data acquisition system 110 settings to match the determined final solution 420 f enables the data acquisition system 110 to reach operational targets (e.g., data acquisition quality) as soon as possible. For example, the first rate of change interval, i, and the second rate of change interval, k, reduce the computational load and simultaneously reduce the time required to determine the final solution 420 f. Furthermore, by analyzing the variance rate of change before analyzing the variance data 416, the amount of first threshold 418, ε, verification computations are reduced.

In the illustrated example of FIG. 3, the data selector 302 accesses new raw sensor data when the acquisition environment changes to ensure that the setting configuration is adjusted in connection with the new acquisition environment. The data stored in the example data repository 304 may be in any data format such as, binary data, comma delimited data, tab, delimited data, structured query language (SQL) structures, etc.

While an example manner of implementing the system tuner 120 of FIGS. 1 and 2 is illustrated in FIG. 3, one or more of the elements, processes and/or devices illustrated in FIG. 3 may be combined, divided, re-arranged, omitted, eliminated and/or implemented in any other way. Further, the example data selector 302, the example data repository 304, the example model generator 306, the example model analyzer 308, the example tentative storage device 310, the example solution identifier 312, the example setting manipulator 314, and/or, more generally, the example system tuner 120 of FIGS. 1-3 may be implemented by hardware, software, firmware and/or any combination of hardware, software and/or firmware. Thus, for example, any of the example data selector 302, the example data repository 304, the example model generator 306, the example model analyzer 308, the example tentative storage device 310, the example solution identifier 312, the example setting manipulator 314, and/or, more generally, the example system tuner 120 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example data selector 302, the example data repository 304, the example model generator 306, the example model analyzer 308, the example tentative storage device 310, the example solution identifier 312, and the example setting manipulator 314 is/are hereby expressly defined to include a non-transitory computer readable storage device or storage disk such as a memory, a digital versatile disk (DVD), a compact disk (CD), a Blu-ray disk, etc. including the software and/or firmware. Further still, the example system tuner 120 of FIGS. 1-3 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

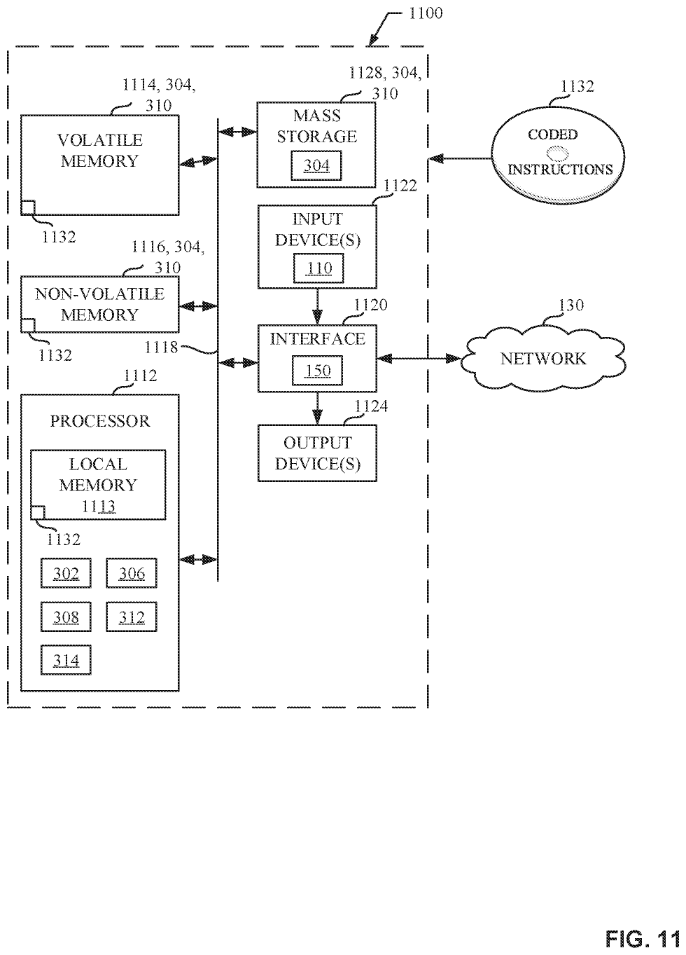

Flowcharts representative of example hardware logic, machine-readable instructions, hardware implemented state machines, and/or any combination thereof for implementing the system tuner of FIGS. 1-3 are shown in FIGS. 5-10. The machine-readable instructions may be one or more executable programs or portion(s) of an executable program for execution by a computer processor such as the processor 1112 shown in the example processor platform 1100 discussed below in connection with FIG. 11. The programs may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowcharts illustrated in FIGS. 5-10, many other methods of implementing the example system tuner 120 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5-10 may be implemented using executable instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

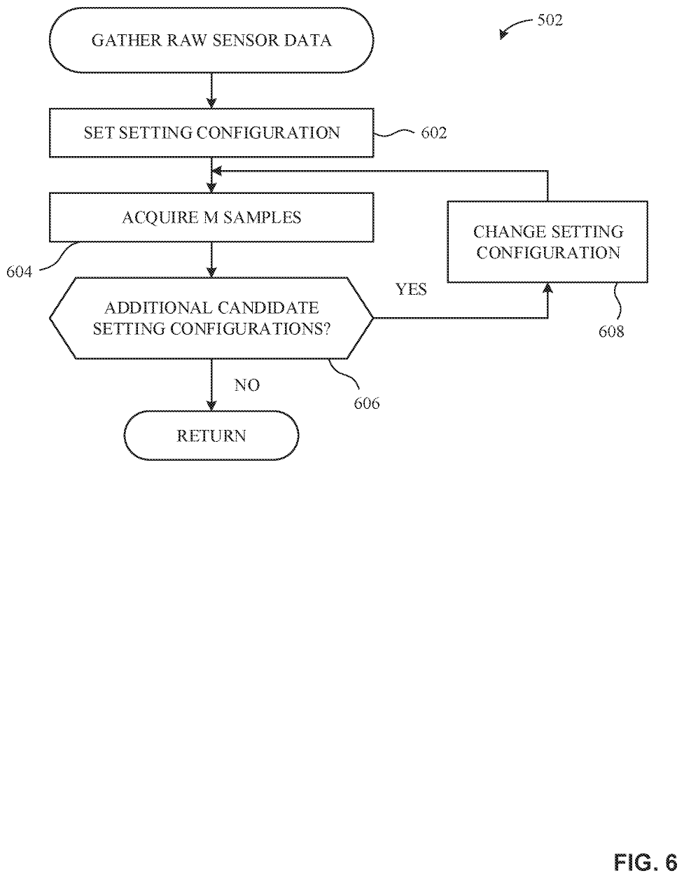

The flowchart of FIG. 5 is representative of example machine-readable instructions that may be executed to implement the system tuner 120 of FIGS. 1, 2, and/or 3. The example machine-readable instructions of FIG. 5 begin at block 502 at which the system tuner 120 gathers raw sensor data. For example, the data selector 302 (FIG. 3) gathers data from the data acquisition system 110 at each setting configuration of interest. In such examples, the setting manipulator 314 can change the settings of the data acquisition system 110 while the data selector 302 gathers the raw sensor data at each setting configuration permutation of interest. Additional detail in connection with gathering raw sensor data (block 502) is shown in FIG. 6 and described later in further detail.

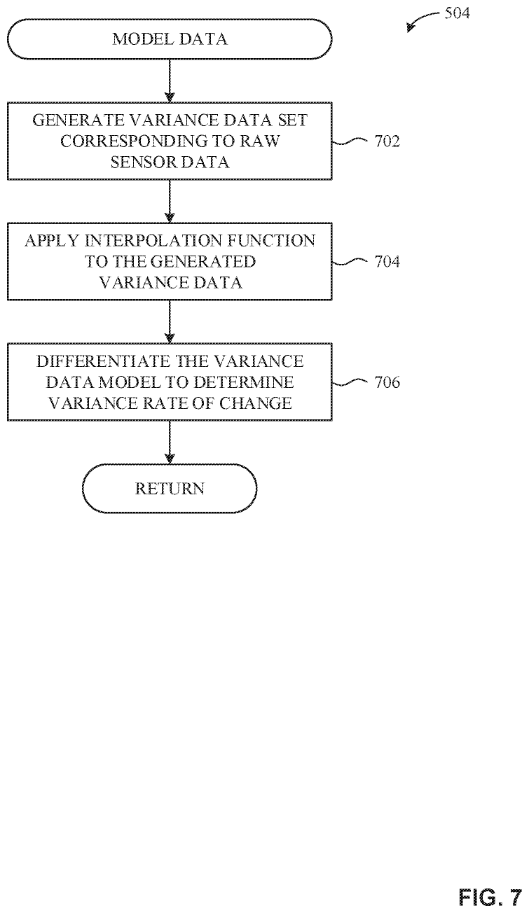

At block 504, the example system tuner 120 models the raw sensor data. For example, the model generator 306 generates variance data 416 based on the raw sensor data and models the variance data 416 as a function, h(x), shown in FIG. 4B, where x represents the sample. The example model generator 306 then differentiates the variance data model 426 to determine the rate at which the variance data 416 is changing at each sample within the variance data 416. The variance rate of change model 430 is defined as h′(x) and shown in FIG. 4C. Additional detail in connection with modeling the raw sensor data (block 504) is shown in FIG. 7 and described later in further detail.

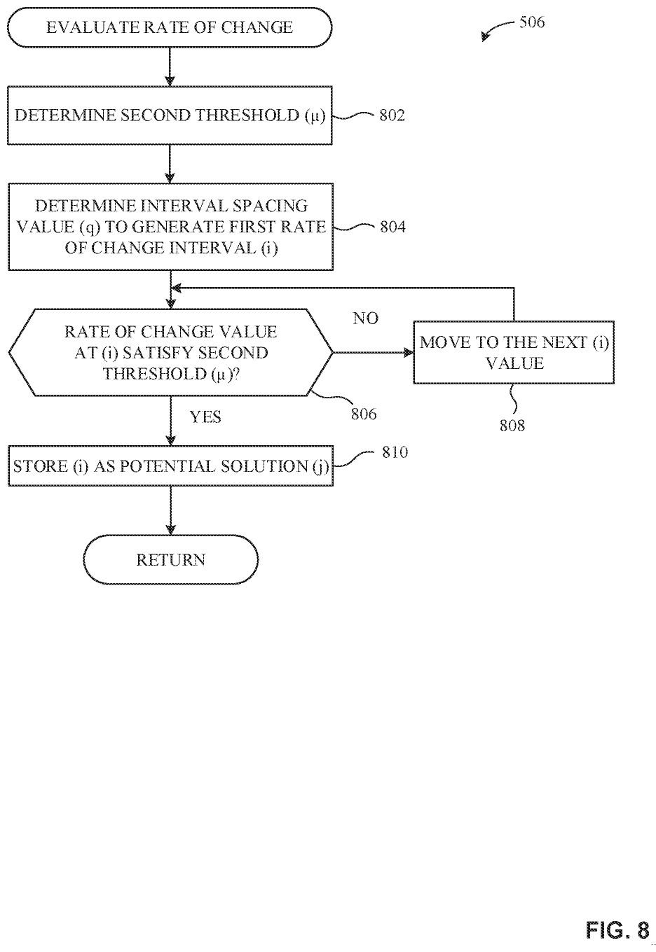

At block 506, the example system tuner 120 evaluates the variance rate of change model 430 to determine a potential solution j. For example, the model analyzer 308 iteratively evaluates the variance rate of change model 430 at a first rate of change interval, i, to identify the potential solution. In such examples, the model analyzer 308 iteratively evaluates the variance rate of change data until a sample within the first rate of change interval satisfies the second threshold 432A, 432B, p, (e.g., h′(i)). Additional detail in connection with evaluating the variance rate of change model 430 to determine a potential setting configuration solution (block 506) is shown in FIG. 8 and described later in further detail.

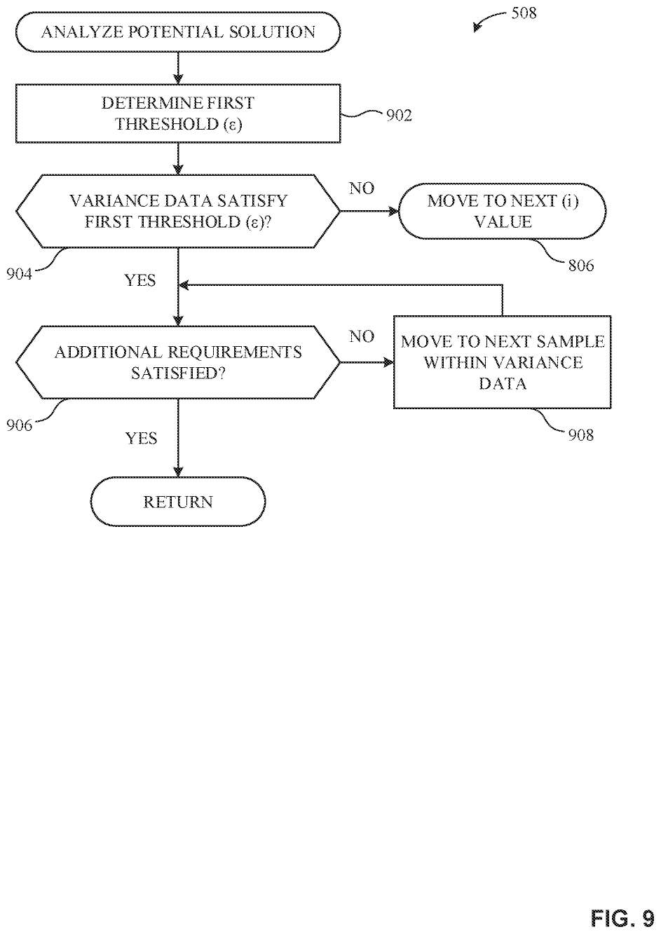

At block 508, the example system tuner 120 analyzes the potential solution, determined by the model analyzer 308, to ensure that the potential solution satisfies the first threshold 418, E. For example, the solution identifier 312 analyzes the potential solution to ensure that the variance data value, h(j), satisfies the first threshold 418, ε. In such examples, other user-defined criteria and/or additional requirements are iteratively analyzed by the solution identifier 312 to ensure that user-defined criteria and/or additional requirements are satisfied. Additional detail in connection with analyzing the potential solution (block 508) is shown in FIG. 9 and described later in further detail.

At block 510, the example system tuner 120 evaluates the variance rate of change values succeeding the potential solution. As described above, because the potential solution could be a local minimum, the example system tuner 120 verifies whether one or more temporally subsequent data samples continues to satisfy one or more thresholds of interest. If so, then the example model analyzer 308 designates the potential solution as the final solution 420. For example, the model analyzer 308 uses the potential solution, determined by the solution identifier 312, as the starting point for a second rate of change interval, k. The model analyzer 308 evaluates the rate of change of each sample within the second rate of change interval, k, to ensure that the succeeding values stay below the second threshold 432A, 432B, μ, previously evaluated. Additional detail in connection with evaluating the variance rate of change values succeeding the potential solution (block 510) is shown in FIG. 10 and described later in further detail.

At block 512, the example system tuner 120 manipulates the data acquisition system 110 settings based on the final solution 420 f. For example, the setting manipulator 314 uses the final solution 420, determined by the model analyzer 308, to identify the corresponding setting configuration. The setting manipulator 314 manipulates the settings of the data acquisition system 110 to match the identified setting configuration.

At block 514, the example system tuner 120 determines whether the environment at which the data acquisition system 110 is operating has changed. For example, the data selector 302 evaluates the raw sensor data being acquired by the data acquisition system to determine whether the system tuner 120 needs to adjust the settings of the data acquisition system 120. If, at block 514 the data selector 302 determines that the environment has changed and the system tuner 120 needs to adjust the settings of the data acquisition system 110, then, the system tuner 120 re-runs the machine-readable instructions starting back at block 502. If, at block 514, the data selector 302 determines that the environment has not changed and/or not changed enough to require the system tuner 120 to adjust the data acquisition system 110, then, the machine-readable instructions of FIG. 5 continue to monitor the environment (e.g., the application) until a threshold change occurs. In that case, control returns to block 502.

The flowchart of FIG. 6 is representative of example machine-readable instructions that may be executed implement block 502 of FIG. 5. The example machine-readable instructions of FIG. 6 begin at block 602 at which the system tuner 120 sets an initial setting configuration. For example, the setting manipulator 314 sets an initial setting configuration for the data acquisition system 110. In some examples, the setting manipulator 314 sets each of the parameter settings 410, 412 to the highest and/or lowest possible settings to progressively gather the raw sensor data as shown in FIG. 4A. For example, as shown in FIG. 4A, the initial setting configuration is shown as the combination of 410A and 412A. Alternatively, the setting manipulator 314 may set the parameter settings 410, 412 to any other initial configuration and rearrange the raw sensor data once it has been gathered.

At block 604, the example system tuner 120 acquires m number of samples. For example, the data selector 302 acquires m number of samples for the current setting configuration set by the setting manipulator 314. For instance, the number of samples gathered for the example shown in FIG. 4A is twenty samples per setting configuration. In some examples, m can be any integer greater than zero and is user-defined and/or application defined. Typically, reducing the value of m is helpful to reduce the number of samples stored in the data repository 304.

At block 606, the example system tuner 120 determines whether raw sensor data needs to be gathered for additional candidate setting configurations. For example, the data selector 302 identifies the amount of possible setting configurations and compares that to the amount of raw sensor data already gathered to determine whether raw sensor data needs to be gathered for additional candidate setting configurations. If, at block 606, the data selector 302 determines that more raw sensor data needs to be gathered for additional candidate setting configurations, then, at block 608, the setting manipulator 314 changes the setting configurations of the data acquisition system 110 to a setting configuration that has not yet been set. If, at block 606, the data selector 302 determines that there are no additional candidate setting configurations to gather raw sensor data from, then, the machine-readable instructions of FIG. 6 return to block 504 of FIG. 5.

The flowchart of FIG. 7 is representative of example machine-readable instructions that may be executed to implement block 504 of FIG. 5. The example machine-readable instructions of FIG. 7 begin at block 702 at which the example system tuner 120 generates variance data 416 corresponding to the raw sensor data. For example, the model generator 306 uses the raw sensor data, previously gathered by the data selector 302, and generates variance data 416. In such examples, the variance data 416 is stored in the data repository 304.

At block 704, the example system tuner 120 applies an interpolation function to the generated variance data 416. For example, the model generator 306 best fits a polynomial to the variance data 416 by applying the method of non-linear least squares and using floating point. The polynomial is a functional representation of the variance data 416, h(x), and is applied to more easily identify topography/data trends.

At block 706, the example system tuner 120 differentiates the variance data model 426 to determine the variance rate of change model 430, h′(x). For example, the model generator 306 differentiates the variance data model 426 to generate a function that determines the rate of change at each sample within the variance data 416. The variance rate of change model 430 is used to acquire insight into the topology of the variance data 416 and/or to help illustrate different degrees of transient behavior(s) associated with an environment or system under test/analysis. Control then returns to block 506 of FIG. 5.

The flowchart of FIG. 8 is representative of example machine-readable instructions that may be executed to implement block 506 of FIG. 5. The example machine-readable instructions of FIG. 8 begin at block 802 at which the example system tuner 120 determines the second threshold 432A, 432B, μ. For example, the model analyzer 308 determines the second threshold 432A, 432B, μ, deemed acceptable by the user and/or application. In some examples, the second threshold 432A, 432B, μ, is a variance rate of change percentage, but can alternatively be any other rate of change variable measured by the sensors 170 and/or data acquisition system 110.

At block 804, the example system tuner 120 determines an interval spacing value to generate the first rate of change interval, i. For example, the model analyzer 308 determines the interval spacing value, q, to generate the first rate of change interval, i. In some examples, q is an integer value that defines the spacing between each value within the first rate of change interval. In other examples, q can be a function that changes the spacing throughout the first rate of change interval. In such examples, the interval spacing, q, is determined by the user but may alternatively be determined by the application. The first rate of change interval, i, is determined by the spacing value, q, and is used by the model analyzer 308 to reduce the number of variance rate of change values analyzed.

At block 806, the example system tuner 120 determines whether variance rate of change values, at the first rate of change interval i, satisfy the second threshold 432A, 432B, μ. For example, the model analyzer 308 analyzes the absolute value of the rate of change value at the first un-analyzed sample, i, to determine whether the absolute value is below the second threshold 432A, 432B, μ, (e.g., |h′(i)|<μ). If, at block 806, the example model analyzer 308 determines that the variance rate of change value at i does not satisfy the second threshold 432A, 432B, μ, then, at block 808, the example model analyzer 308 moves to the next value of i. If, at block 808, the example model analyzer 308 determines that the variance rate of change value at i satisfies the second threshold 432A, 432B, μ, then, at block 810, the example model analyzer 308 stores the value of i in the example tentative repository 310 as a potential solution, j, and the instructions of FIG. 8 conclude.

The flowchart of FIG. 9 is representative of example machine-readable instructions that may be executed to implement the block 508 of FIG. 5. The example machine-readable instructions of FIG. 9 begin at block 902 at which the system tuner 120 determines the first threshold 418, ε. For example, the solution identifier 312 determines the first threshold 418, ε, deemed acceptable by the user and/or application. In some examples, the first threshold 418, ε, is a percentage, but can alternatively be any other variable measured by the sensors 170 and/or data acquisition system 110.

At block 904, the example system tuner 120 determines whether the variance data at j satisfies the first threshold 418, E. For example, the solution identifier 312 analyzes the variance value at the potential solution, j, to determine whether the variance value satisfies the first threshold 418, ε, (e.g., h(j)<ε). If, at block 904, the example solution identifier 312 determines that the potential solution variance value does not satisfy the first threshold 418, ε, then, the instructions of FIG. 9 return to block 806 of FIG. 8 and move to the next i value within the first rate of change interval. If, at block 904 the example solution identifier 312 determines that the potential solution variance value satisfies the first threshold 418, ε, then, at block 906, the example system tuner 120 determines whether all user-defined criteria and/or additional requirements are satisfied.

At block 906, the example system tuner 120 determines whether all user-defined criteria and/or additional requirements are satisfied at the potential solution j. For example, the solution identifier 312 analyzes any user-defined criteria and/or additional requirements, set forth by the user and/or application, and determines whether the potential solution j satisfies those user-defined criteria and/or additional requirements. If, at block 906, the example solution identifier 312 determines that the user-defined criteria and/or additional requirements are not satisfied, then, at block 908, the solution identifier 312 moves to the next sample within the variance data 416. If, at block 906, the example solution identifier 312 determines that the user-defined criteria and/or additional requirements are satisfied, then, at block 908, the instructions of FIG. 9 return to block 510 of FIG. 5.

The flowchart of FIG. 10 is representative of example machine-readable instructions that may be executed to implement block 510 of FIG. 5. The example machine-readable instructions of FIG. 10 begin at block 1002 at which the example system tuner 120 determines a second rate of change interval, k. For example, the model analyzer 308 determines the second rate of change interval, k, where k is the 2^{nd}, 4^{th}, 8^{th}, 16^{th}, 256^{th} value succeeding the potential solution and the potential solution, j, is the start of the interval, k.

At block 1004, the example system tuner 120 analyzes variance rate of change values succeeding the potential solution at the second rate of change interval, k. For example, the model analyzer 308 analyzes the variance rate of change value at each sample within the second rate of change interval, k. Evaluating the variance rate of change at the interval, k, provides a level of verification that all remaining samples will remain equal to or less than the second threshold 432A, 432B, p. As mentioned above, because of the possibility of local minimums in the variance data 416, the second rate of change interval, k, helps to prevent selecting a local minimum as a final solution 420.

At block 1006, the example system tuner 120 determines whether all of the variance rate of change values analyzed at the k interval satisfy the second threshold 432A, 432B, p. For example, the model analyzer 308 determines the variance rate of change values at each k sample and compares the variance rate of change values to the second threshold 432A, 432B, p. If, at block 1006 the example model analyzer 308 determines that at least one variance rate of change value did not satisfy the second threshold 432A, 432B, p, then, the instructions of FIG. 10 move to block 806 of FIG. 8. If, at block 1006, the example model analyzer 308 determines that all of the variance rate of change values satisfy the second threshold 432A, 432B, p, then, at block 1008, the example model analyzer 308 stores the potential solution, j, as the final solution 420, f, in the tentative storage device 310 and the instructions of FIG. 10 return to block 512 of FIG. 5. The final solution 420, f, determined by the model analyzer 308, provides a user-defined level of data acquisition to the data acquisition system 110 as soon as possible and with a reduced amount of computations.

FIG. 11 is a block diagram of an example processor platform 1100 structured to execute the instructions of FIGS. 5-10 to implement the system tuner 120 of FIGS. 1, 2, and 3. The processor platform 1100 can be, for example, an ASIC, an FPGA, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the data selector 302, the model generator 306, the model analyzer 308, the solution identifier 312, and the setting manipulator 314,

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a proximity sensor, a pressure sensor, a voltage sensor, and/or any other type of data acquisition device or sensor.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.). The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132 of FIGS. 5-10 may be stored in the mass storage device 1128, in the volatile memory 1114, in the non-volatile memory 1116, and/or on a removable non-transitory computer readable storage medium such as a CD or DVD. In the illustrated example of FIG. 11, the example mass storage device 1128 implements the example data repository 304. In the illustrated example of FIG. 11, the example volatile memory 1114 implements the tentative storage device 310.

From the foregoing, it will be appreciated that example methods, systems, articles of manufacture, and apparatus have been disclosed that improve the speed at which the tuning of a data acquisition system can be accomplished in an edge-based deployment. The disclosed methods, apparatus and articles of manufacture improve the efficiency of using a computing device by implementing intervals, for determining and validating potential solutions, that limit the number of iterations required. The disclosed methods, apparatus and articles of manufacture are accordingly directed to one or more improvement(s) in the functioning of a computer.

Example methods, apparatus, systems, and articles of manufacture to control data acquisition settings in edge-based deployments are disclosed herein. Further examples and combinations thereof include the following:

Example 1 includes an apparatus to dynamically adjust data acquisition settings, the apparatus comprising a model generator to transform sensor data to variance data, and differentiate the variance data to generate variance rate of change data, a model analyzer to determine subsets of the variance rate of change data associated with respective data acquisition settings, determine a count of data points corresponding to the rate of change data, and determine an interval spacing value based on the count of the data points and a number of subsets of the variance rate of change data, and a solution identifier to calculate candidate solutions at respective ones of the data points corresponding to the interval spacing value, respective ones of the candidate solutions corresponding to respective data acquisition settings of a data acquisition system, and select one of the candidate solutions satisfying an operational threshold of the data acquisition system.

Example 2 includes the apparatus as defined in example 1, wherein the model analyzer is to determine whether the selected one of the candidate solutions is a false positive by selecting one of the count of data points corresponding to the rate of change data that is subsequent to the selected one of the candidate solutions.

Example 3 includes the apparatus as defined in example 2, further including a setting manipulator to assign the data acquisition system with data acquisition settings corresponding to the selected one of the candidate solutions when the subsequently selected data point satisfies the operational threshold.

Example 4 includes the apparatus as defined in example 3, wherein the setting manipulator is to assign the data acquisition settings as at least one of a data acquisition frequency, a data sample dwell duration, or a data sample resolution.

Example 5 includes the apparatus as defined in example 2, wherein the solution identifier is to cease further data point analysis in response to the model analyzer determining the subsequently selected data point satisfies the operational threshold.

Example 6 includes the apparatus as defined in example 1, wherein the solution identifier is to determine whether the operational threshold includes at least one of a variance threshold value or a rate of change variance window threshold.

Example 7 includes the apparatus as defined in example 1, wherein the model generator is to differentiate the variance data with a polynomial function having a polynomial degree of sixteen.

Example 8 includes the apparatus as defined in example 1, wherein the variance data is based on a number of data acquisition system settings and a number of samples per setting configuration.

Example 9 includes At least one non-transitory computer-readable medium comprising instructions that, when executed, cause at least one processor to at least transform sensor data to variance data, differentiate the variance data to generate variance rate of change data, determine subsets of the variance rate of change data associated with respective data acquisition settings, determine a count of data points corresponding to the rate of change data, determine an interval spacing value based on the count of the data points and a number of subsets of the variance rate of change data, calculate candidate solutions at respective ones of the data points corresponding to the interval spacing value, respective ones of the candidate solutions corresponding to respective data acquisition settings of a data acquisition system, and select one of the candidate solutions satisfying an operational threshold of the data acquisition system.

Example 10 includes the computer readable medium as defined in example 9, wherein the instructions, when executed, cause the at least one processor to determine whether the selected one of the candidate solutions is a false positive by selecting one of the count of data points corresponding to the rate of change data that is subsequent to the selected one of the candidate solutions.

Example 11 includes the computer readable medium as defined in example 10, wherein the instructions, when executed, cause the at least one processor to assign the data acquisition system with data acquisition settings corresponding to the selected one of the candidate solutions when the subsequently selected data point satisfies the operational threshold.

Example 12 includes the computer readable medium as defined in example 11, wherein the instructions, when executed, cause the at least one processor to assign the data acquisition settings as at least one of a data acquisition frequency, a data sample dwell duration, or a data sample resolution.

Example 13 includes the computer readable medium as defined in example 10, wherein the instructions, when executed, cause the at least one processor to cease further data point analysis in response to the model analyzer determining the subsequently selected data point satisfies the operational threshold.

Example 14 includes the computer readable medium as defined in example 9, wherein the instructions, when executed, cause the at least one processor to determine whether the operational threshold includes at least one of a variance threshold value or a rate of change variance window threshold.

Example 15 includes the computer readable medium as defined in example 9, wherein the instructions, when executed, cause the at least one processor to differentiate the variance data with a polynomial function having a polynomial degree of sixteen.

Example 16 includes the computer readable medium as defined in example 9, wherein the instructions, when executed, cause the at least one processor to calculate the variance data based on a number of data acquisition system settings and a number of samples per setting configuration.

Example 17 includes a method to dynamically adjust data acquisition settings, the method comprising transforming, by executing an instruction with a processor, sensor data to variance data, differentiating, by executing an instruction with the processor, the variance data to generate variance rate of change data, determining, by executing an instruction with the processor, subsets of the variance rate of change data associated with respective data acquisition settings, determining, by executing an instruction with the processor, a count of data points corresponding to the rate of change data, determining, by executing an instruction with the processor, an interval spacing value based on the count of the data points and a number of subsets of the variance rate of change data, calculating, by executing an instruction with the processor, candidate solutions at respective ones of the data points corresponding to the interval spacing value, respective ones of the candidate solutions corresponding to respective data acquisition settings of a data acquisition system, and selecting, by executing an instruction with the processor, one of the candidate solutions satisfying an operational threshold of the data acquisition system.

Example 18 includes the method as defined in example 17, further including determining whether the selected one of the candidate solutions is a false positive by selecting one of the count of data points corresponding to the rate of change data that is subsequent to the selected one of the candidate solutions.

Example 19 includes the method as defined in example 18, further including assigning the data acquisition system with data acquisition settings corresponding to the selected one of the candidate solutions when the subsequently selected data point satisfies the operational threshold.

Example 20 includes the method as defined in example 19, further including assigning the data acquisition settings as at least one of a data acquisition frequency, a data sample dwell duration, or a data sample resolution.

Example 21 includes the method as defined in example 18, further including ceasing further data point analysis in response to the model analyzer determining the subsequently selected data point satisfies the operational threshold.

Example 22 includes the method as defined in example 17, further including determining whether the operational threshold includes at least one of a variance threshold value or a rate of change variance window threshold.

Example 23 includes the method as defined in example 17, further including differentiating the variance data with a polynomial function having a polynomial degree of sixteen.

Example 24 includes the method as defined in example 17, further including calculating the variance data based on a number of data acquisition system settings and a number of samples per setting configuration.

Although certain example methods, systems, articles of manufacture, and apparatus have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus to dynamically adjust data acquisition settings, the apparatus comprising:
a model generator to:
transform sensor data to variance data; and
differentiate the variance data to generate variance rate of change data;
a model analyzer to:
determine subsets of the variance rate of change data associated with respective data acquisition settings;
determine a count of data points corresponding to the rate of change data; and
determine an interval spacing value based on the count of the data points and a number of subsets of the variance rate of change data; and
a solution identifier to:
calculate candidate solutions at respective ones of the data points corresponding to the interval spacing value, respective ones of the candidate solutions corresponding to respective data acquisition settings of a data acquisition system; and
select one of the candidate solutions satisfying an operational threshold of the data acquisition system.

2. The apparatus as defined in claim 1, wherein the model analyzer is to determine whether the selected one of the candidate solutions is a false positive by selecting one of the count of data points corresponding to the rate of change data that is subsequent to the selected one of the candidate solutions.

3. The apparatus as defined in claim 2, further including a setting manipulator to assign the data acquisition system with data acquisition settings corresponding to the selected one of the candidate solutions when the subsequently selected data point satisfies the operational threshold.

4. The apparatus as defined in claim 3, wherein the setting manipulator is to assign the data acquisition settings as at least one of a data acquisition frequency, a data sample dwell duration, or a data sample resolution.

5. The apparatus as defined in claim 2, wherein the solution identifier is to cease further data point analysis in response to the model analyzer determining the subsequently selected data point satisfies the operational threshold.

6. The apparatus as defined in claim 1, wherein the solution identifier is to determine whether the operational threshold includes at least one of a variance threshold value or a rate of change variance window threshold.

7. The apparatus as defined in claim 1, wherein the model generator is to differentiate the variance data with a polynomial function having a polynomial degree of 16.

8. The apparatus as defined in claim 1, wherein the variance data is based on a number of data acquisition system settings and a number of samples per setting configuration.

9. At least one non-transitory computer-readable medium comprising instructions that, when executed, cause at least one processor to at least:
transform sensor data to variance data;
differentiate the variance data to generate variance rate of change data;
determine subsets of the variance rate of change data associated with respective data acquisition settings;
determine a count of data points corresponding to the rate of change data;
determine an interval spacing value based on the count of the data points and a number of subsets of the variance rate of change data;
calculate candidate solutions at respective ones of the data points corresponding to the interval spacing value, respective ones of the candidate solutions corresponding to respective data acquisition settings of a data acquisition system; and
select one of the candidate solutions satisfying an operational threshold of the data acquisition system.

10. The computer readable medium as defined in claim 9, wherein the instructions, when executed, cause the at least one processor to determine whether the selected one of the candidate solutions is a false positive by selecting one of the count of data points corresponding to the rate of change data that is subsequent to the selected one of the candidate solutions.

11. The computer readable medium as defined in claim 10, wherein the instructions, when executed, cause the at least one processor to assign the data acquisition system with data acquisition settings corresponding to the selected one of the candidate solutions when the subsequently selected data point satisfies the operational threshold.

12. The computer readable medium as defined in claim 11, wherein the instructions, when executed, cause the at least one processor to assign the data acquisition settings as at least one of a data acquisition frequency, a data sample dwell duration, or a data sample resolution.

13. The computer readable medium as defined in claim 10, wherein the instructions, when executed, cause the at least one processor to cease further data point analysis in response to the model analyzer determining the subsequently selected data point satisfies the operational threshold.

14. The computer readable medium as defined in claim 9, wherein the instructions, when executed, cause the at least one processor to determine whether the operational threshold includes at least one of a variance threshold value or a rate of change variance window threshold.

15. The computer readable medium as defined in claim 9, wherein the instructions, when executed, cause the at least one processor to differentiate the variance data with a polynomial function having a polynomial degree of 16.

16. The computer readable medium as defined in claim 9, wherein the instructions, when executed, cause the at least one processor to calculate the variance data based on a number of data acquisition system settings and a number of samples per setting configuration.

17. A method to dynamically adjust data acquisition settings, the method comprising:
transforming, by executing an instruction with a processor, sensor data to variance data;
differentiating, by executing an instruction with the processor, the variance data to generate variance rate of change data;
determining, by executing an instruction with the processor, subsets of the variance rate of change data associated with respective data acquisition settings;
determining, by executing an instruction with the processor, a count of data points corresponding to the rate of change data;
determining, by executing an instruction with the processor, an interval spacing value based on the count of the data points and a number of subsets of the variance rate of change data;
calculating, by executing an instruction with the processor, candidate solutions at respective ones of the data points corresponding to the interval spacing value, respective ones of the candidate solutions corresponding to respective data acquisition settings of a data acquisition system; and
selecting, by executing an instruction with the processor, one of the candidate solutions satisfying an operational threshold of the data acquisition system.

18. The method as defined in claim 17, further including determining whether the selected one of the candidate solutions is a false positive by selecting one of the count of data points corresponding to the rate of change data that is subsequent to the selected one of the candidate solutions.

19. The method as defined in claim 18, further including assigning the data acquisition system with data acquisition settings corresponding to the selected one of the candidate solutions when the subsequently selected data point satisfies the operational threshold.

20. The method as defined in claim 19, further including assigning the data acquisition settings as at least one of a data acquisition frequency, a data sample dwell duration, or a data sample resolution.

21. The method as defined in claim 18, further including ceasing further data point analysis in response to the model analyzer determining the subsequently selected data point satisfies the operational threshold.

22. The method as defined in claim 17, further including determining whether the operational threshold includes at least one of a variance threshold value or a rate of change variance window threshold.

23. The method as defined in claim 17, further including differentiating the variance data with a polynomial function having a polynomial degree of 16.

24. The method as defined in claim 17, further including calculating the variance data based on a number of data acquisition system settings and a number of samples per setting configuration.
